(19) United States
(12) Patent Application Publication
(10) Pub. No.: US 2013/0063472 A1
(43) Pub. Date: Mar. 14, 2013

(54) CUSTOMIZED IMAGE FILTERS

(71) Applicants: SCOTT MARISON, Honolulu, HI (US); Jean Pierre Duplessis, Kirkland, WA (US); Justin Goshi, Honolulu, HI (US); Emmanuel Athans, Seattle, WA (US)

(72) Inventors: SCOTT MARISON, Honolulu, HI (US); Jean Pierre Duplessis, Kirkland, WA (US); Justin Goshi, Honolulu, HI (US); Emmanuel Athans, Seattle, WA (US)

(73) Assignee: Microsoft Corporation, Redmond, WA (US)

(21) Appl. No.: 13/553,842

(22) Filed: Jul. 20, 2012

Related U.S. Application Data
(63) Continuation-in-part of application No. 13/227,498, filed on Sep. 8, 2011.

(51) Int. Cl. G09G 5/02

(52) U.S. Cl. 345/591

(57) ABSTRACT

An interactive development environment enables a user to create a customized image filter through a user interface that provides the developer with a capability to create a directed acyclic graph representing the mathematical operations and values that generate a customized visual effect. During development of the customized image filter, a visual shader designer engine may execute the operations and values associated with each node in a prescribed order and display the rendered outcome in the render view area of each node. In this manner, the developer is able to quickly visualize the visual effect produced by the image filter in real time.

### CROSS-REFERENCE TO RELATED APPLICATION

This application is a continuation-in-part of U.S. patent application Ser. No. 13/227,498 filed on Sep. 8, 2011.

### BACKGROUND

Advances in computer graphics have produced sophisticated software to make computer-generated images appear as realistic as possible. In particular, shaders are often used in graphic systems to generate user-designed graphic effects. A shader is a program or code that defines a set of operations to be performed on a geometric object to produce a desired graphic effect. A pixel shader is one type of shader that is used to produce a color for each pixel on each surface of a geometric object. A pixel shader may be used to render effects such as fog, diffusion, motion blur, reflections, texturing, or depth on objects in an image.

A shader performs complex operations and may contain thousands of instructions running potentially hundreds of threads of execution in parallel on a graphics processing unit (GPU). For this reason, the development of a shader may be a daunting task. In particular, testing a shader is problematic since the developer may not have access to the internal registers and data of the various hardware components of the GPU which may be needed to analyze errors in the shader code. Classic debugging techniques, such as embedding print statements in the shader code, may not be practical when the shader involves a large amount of data and executes in multiple parallel threads. Accordingly, the complexity of a shader provides obstacles for developing such programs.

An image filter utilizes a pixel shader to generate a special visual effect onto an image. For example, an image filter that generates a blur applies a Gaussian transformation on a set of pixels to reduce the detail of the image resulting in a diffused image. A sepia image filter transforms a set of pixels to light or dark brown tones. A ripple image filter displaces a set of pixels with horizontal or vertical waves or ripples.

An image filter may be a predefined function that operates in a prescribed manner which is useful when a developer needs to develop an image quickly. The predefined image filter may not afford a developer the ability to create a unique visual effect leaving the developer with the alternative of creating their own customized image filter. The customized image filter is often written in a high level programming language and translated into executable instructions supported by the graphics subsystem. The customized image filter may then be incorporated into an image editor as a plug-in or as an extension. However, the creation of such a customized image filter in this manner requires that the developer possess programming skills and knowledge.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Shaders are specialized programs that perform certain mathematical transformations on graphics data. A pixel shader operates on each pixel of an image and applies transformations that produce the color of a pixel. A pixel shader may add transformations to approximate the appearance of wood, marble, or other natural materials and/or to approximate the effects of lighting sources on an object.

An interactive development environment is provided that enables a developer to create a directed acyclic graph representing a pixel shader. The directed acyclic graph contains a number of nodes and edges, where each node contains a code fragment that performs an operation on inputs to the node or generates a value. The interactive development environment contains a visual shader designer engine that executes the operations in each node in a prescribed order and displays the rendered outcome in a render view area in the node. In this manner, the developer is able to visually recognize any erroneous results in the creation of the shader in real time while developing the shader.

In addition, the interactive development environment enables a developer to generate a customized image filter through a user interface that provides the developer with a capability to create a directed acyclic graph representing the mathematical operations and values that comprise the customized image filter. During development of the customized image filter, the developer is able to visualize the result of the operations performed by the image filter through a real time rendered view in each node. The visual shader designer engine may initiate execution of the operations associated with each node in the directed acyclic graph in the prescribed order on the graphics hardware and display the rendered outcome in the render view area in each node. In this manner, the developer is able to quickly visualize the visual effect produced by the image filter in real time and to correct any unintended results.

Once the directed acyclic graph is finalized, the graph is transformed into a set of executable instructions that may be saved to a file. The developer may apply the set of executable instructions, representing the customized image file, to an image, or portion thereof, to produce the intended visual effect onto the image.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF DRAWINGS

FIG. 1 is a block diagram illustrating an exemplary graphics pipeline.

FIG. 2 illustrates a first exemplary directed acyclic graph representing a pixel shader.

FIG. 3 illustrates a second exemplary directed acyclic graph representing a pixel shader.

FIG. 4 is a block diagram illustrating a system for designing a pixel shader and an image filter.

FIG. 5 is a flow diagram illustrating a first exemplary method for designing a pixel shader.

FIG. 6 is a flow diagram illustrating a second exemplary method for designing a pixel shader and an image filter.

FIG. 7 is a flow diagram illustrating a third exemplary method for designing a pixel shader and an image filter.

FIG. 8 is a third exemplary directed acyclic graph representing a customized image filter producing a ripple effect.

FIG. 9 is a block diagram illustrating an exemplary system for editing an image with a customized image filter.

FIG. 10 is a flow diagram illustrating a first exemplary method for creating a customized image filter.

FIG. 11 is a flow diagram illustrating a first exemplary method for applying a customized image filter to an image.

FIG. 12 is a flow diagram illustrating a second exemplary method for creating a customized image filter.

FIG. 13 is a flow diagram illustrating a second exemplary method for applying a customized image filter to an image.

FIG. 14 is a block diagram illustrating an operating environment.

FIG. 15 is a block diagram illustrating a first exemplary computing device.

FIG. 16 is a block diagram illustrating a second exemplary computing device.

### DETAILED DESCRIPTION

Various embodiments are directed to a technology for designing a visual shader having a real-time image rendering capability. In one or more embodiments, the visual shader is a pixel shader that may be developed using an interactive development environment. The interactive development environment may have a shader editor that allows a developer to create a directed acyclic graph representing a pixel shader. The directed acyclic graph has a number of nodes and edges. Each node represents an operation to be applied to a graphic image. An operation may be configured as executable instructions written in a shader programming language. The edges connect one node to another node and form a route so that data output from one node is input into another node. All routes in the directed acyclic graph flow in one direction and end at a terminal node that generates the desired color of a pixel. When the nodes in the graph are aggregated in accordance with the routes, the result is a set of code fragments that form the pixel shader.

The interactive development environment includes a visual shader designer engine that generates a rendered view of the result of each node's operation during the design of the directed acyclic graph. Any errors that result in the development of the directed acyclic graph are displayed in the rendered view area of the node. In this manner, the developer is able to visually recognize erroneous results in the creation of the shader while developing the shader.

Further embodiments are directed to a technology for designing an image filter having a real-time image rendering capability. An image filter applies mathematical operations and/or values (collectively referred to as an ‘operation’) on a set of pixels in an image to produce a specific visual effect. An image filter differs from a pixel shader. A pixel shader computes the color of a single pixel. The pixel shader cannot produce complicated visual effects on a portion of an image since the pixel shader does not have knowledge of the image's geometry. For this reason, an image filter is often used to generate the visual effect. Application of an image filter on an image transforms the color of each pixel in the image to a different color that represents the intended visual effect. A pixel shader may be used to perform the transformation on each pixel to include the intended visual effect.

There are various types of well-known image filters, such as, without limitation, a blur, ripple, sepia tone, brighten, bubble, darken, edge detection, emboss, invert colors, sharpen, waterdrops, flip horizontal, flip vertical, whirlpool distortion, nose, Frank Miller shading, and cartoon shading. A blur image filter produces pixels that appear to be out of focus. A ripple image filter distorts an image by adding waves into the image. A sepia image filter re-colors an image with a sepia tone to make the image appear aged. A brighten image filter brightens the color of the pixels in an image. A bubble image filter adds a large distortion bubble into the center of an image. A darken image filter darkens the color of the pixels in an image. An edge detection image filter detects the edges of an image, colors the edges in white, and colors the non-edges black.

An emboss image filter replaces the color of each pixel with a highlight or shadow to produce an embossed effect. An invert color image filter inverts the color of each pixel. A sharpen image filter sharpens the color of each pixel. A waterdrop image filter adds waterdrops onto an image which distorts pixels in certain positions while refracting others. A flip horizontal image filter rearranges the position of the pixels to produce an image that is transformed about a horizontal plane. A flip vertical image filter rearranges the position of the pixels to produce an image that is transformed about a vertical plane. A whirlpool image filter distorts the pixels of an image to generate a vortex or whirlpool effect. A noise image filter adds pseudo-random noise onto an image. A Frank Miller shading image filter converts an image into a high contrast black and white colored image similar to the style of a Frank Miller drawing. A cartoon shade image filter converts an image into a cartoon-like appearance. These image filters and others may be customized for a particular implementation to generate a desired visual effect.

An image is data that can be rasterized onto a visual display. An image may take the form of a drawing, text, photograph, graph, map, pie chart, and the like. An image may be composed of pixels that are stored in files having a predetermined format such as, without limitation, Graphics Interchange Format (GIF), Joint Photographic Experts Group (JPEG), Windows Bitmap (BMP), and the like.

In one or more embodiments, an image filter may be developed using the interactive development environment. The interactive development environment may have a shader editor having a user interface that allows a developer to create a directed acyclic graph representing an image filter. The directed acyclic graph has a number of nodes and edges. Each node represents an operation or value that is applied to an image. An operation may be configured as executable instructions written in a shader programming language. The edges connect one node to another node and form a route so that data output from one node is input into another node. All routes in the directed acyclic graph flow in one direction and end at a terminal node that generates the desired visual effect on a single pixel. When the nodes in the graph are aggregated in accordance with the routes, the result is a set of code fragments that form the customized image filter.

The interactive development environment includes a visual shader designer engine that generates a real-time rendered view of the result of each node's operation during the design of the directed acyclic graph. The rendered view at the terminal node displays a color of a single pixel having the desired visual effect. The visual shader designer engine may initiate execution of the operations associated with each node in the directed acyclic graph in the prescribed order on the graphics hardware and display the rendered outcome in the render view area in each node. Any errors that result in the development of the directed acyclic graph are displayed in the rendered view area of the node. In this manner, the developer is able to visually recognize erroneous results in the creation of the customized image filter while developing the customized image filter.

Upon completion of the creation of the customized image filter, a code segment is formed containing all the executable instructions aggregated from the nodes of the directed acyclic graph. The code segment may be stored and later applied to an image, or portion thereof, to generate the desired visual effect. The application of the customized image filter onto an image often utilizes the pixel shader to produce a new color, for each pixel within the image, that is subject to the customized image filter. Attention now turns to a more detailed discussion of the embodiments of the visual shader designer.

Computer systems are used to develop three dimensional (3D) computer graphics that are rendered onto a two dimensional (2D) computer screen or display. Real world objects are viewed in three dimensions and a computer system generates 2D raster images. Images created with 3D computer graphics are used in various applications that range from video games, aircraft flight simulators, to weather forecast models.

The 3D objects in a graphical representation may be created using mathematical models. The mathematical models are composed of geometric points within a coordinate system having an x, y, and z-axis where the axes correspond to width, height, and depth respectively. The location of a geometric point is defined by its x, y, and z coordinates. A 3D object may be represented as a set of coordinate points or vertices. Vertices may be joined to form polygons that define the surface of an object to be rendered and displayed. The 3D objects are created by connecting multiple 2D polygons. A triangle is the most common polygon used to form 3D objects. A mesh is the set of triangles, vertices, and points that define a 3D object.

The graphics data within the polygons may then be operated on by shaders. Shaders are specialized programs that perform certain mathematical transformations on the graphics data. A vertex shader operates on vertices and applies computations on the positions, colors, and texturing coordinates of the vertices. A pixel shader operates on each pixel and applies transformations that produce the color of a pixel. A pixel shader may add transformations to approximate the appearance of wood, marble, or other natural materials and/or to approximate the effects of lighting sources on an object. The output values generated by the pixel shader may be sent to a frame buffer where they are rendered and displayed onto a screen by the GPU.

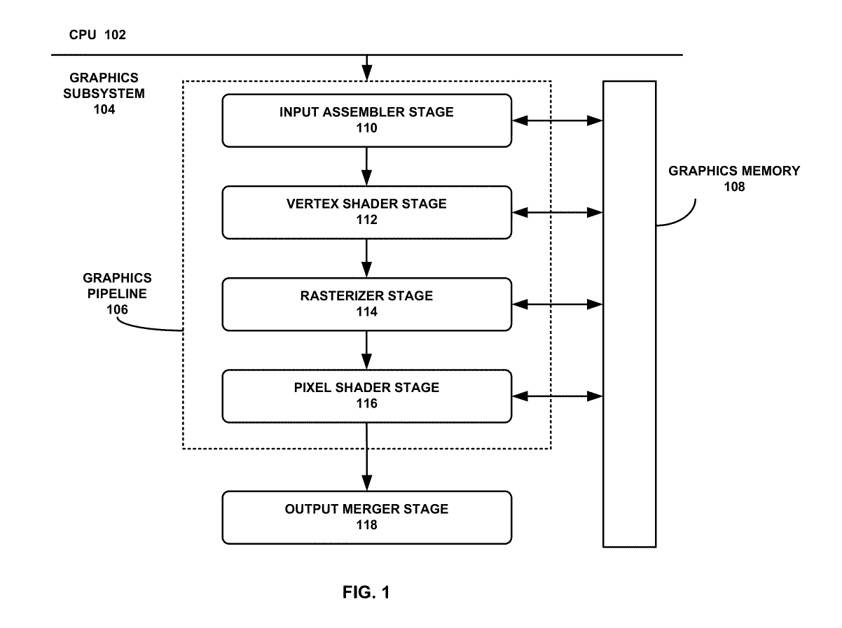

Computer systems typically utilize a graphics pipeline to transform the 3D computer graphics into 2D graphic images. The graphics pipeline includes various stages of processing and may be composed of hardware and/or software components. FIG. 1 illustrates an exemplary graphics subsystem 104 that may have a graphics pipeline 106 and graphics memory 108. The graphics subsystem 104 may be a separate processing unit from the main processor or CPU 102. It should be noted that the graphics subsystem 104 and the graphics pipeline 106 may be representative of some or all of the components of one or more embodiments described herein and that the graphics subsystem 104 and graphics pipeline 106 may include more or less components than that which is described in FIG. 1.

A graphics pipeline 106 may include an input assembler stage 110 that receives input, from an application running on a CPU, representing a graphic image in terms of triangles, vertices, and points. The vertex shader stage 112 receives these inputs and executes a vertex shader which applies transformations of the positions, colors, and texturing coordinates of the vertices. The vertex shader may be a computer program that is executed on a graphics processor unit (GPU). Alternatively, the vertex shader may be implemented in hardware, such as an integrated circuit or the like, or may be implemented as a combination of hardware and software components.

The rasterizer stage 114 is used to convert the vertices, points, and polygons into a raster format containing pixels for the pixel shader. The pixel shader stage 116 executes a pixel shader which applies transformations to produce a color or pixel shader value for each pixel. The pixel shader may be a computer program that is executed on a GPU. Alternatively, the pixel shader may be implemented in hardware, such as an integrated circuit or the like, or may be implemented as a combination of hardware and software components. The output merger stage 118 combines the various outputs, such as pixel shader values, with the rendered target to generate the final rendered image.

A pixel shader operates on pixel fragments to generate a color based on interpolated vertex data as input. The color of a pixel may depend on a surface's material properties, the color of the ambient light, the angle of the surface to the viewpoint, etc. A pixel shader may be represented as a directed acyclic graph (DAG).

A DAG is a directed graph having several nodes and edges and no loops. Each node represents an operation or a value, such a mathematical operation, a color value, an interpolated value, etc. Each edge connects two nodes and forms a path between the connected nodes. A route is formed of several paths and represents a data flow through the graph in a single direction. All routes end at a single terminal node. Each node has at least one input or at least one output. An input may be an appearance value or parameter, such as the color of a light source, texture mapping, etc. An output is the application of the operation defined at a node on the inputs. The final rendered model is represented in the terminal node of the DAG.

Each node in the DAG represents an operation or a value, such a mathematical operation, a color value, an interpolated value, etc. An input may also be the output from another process. The data in a DAG flows in one direction from node to node and terminates at a terminal node. The application of the operations of each node in accordance with the directed routes results in a final color for a pixel that is rendered in the terminal node.

A developer may use an interactive development environment to create a pixel shader and an image filter. The interactive development environment may contain a graphical interface including icons, buttons, menus, check boxes, and the like representing easy-to-use components for constructing a DAG. The components represent mathematical operations or values that are used to define a node. The visual components are linked together to form one or more routes where each route represents a data flow through the DAG executing the operations specified in each node following the order of the route. The data flow ends at a terminal node that renders the final color of the object. In one or more embodiments, the interactive development environment may be Microsoft's Visual Studio® product.

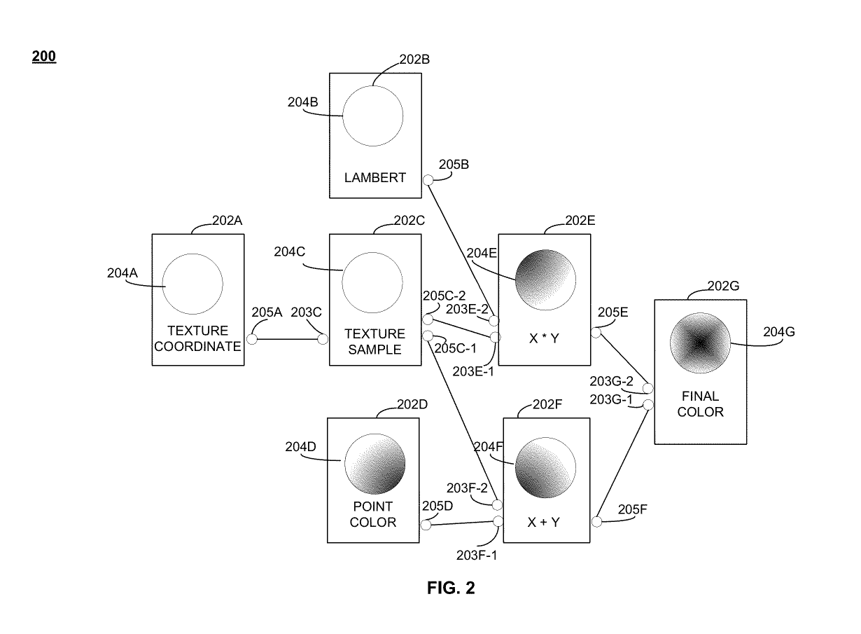

FIG. 2 illustrates a pixel shader embodied as a DAG 200 having been constructed in an interactive development environment using visual components. The DAG 200 represents a pixel shader that shades objects based upon a light source, using a Lambert or diffuse lighting model. The DAG 200 has seven nodes 202A-202G connected to form directed routes that end at a terminal node 202G. Each node, 202A-202G, may have zero or more inputs, 203C, 203E-1, 203E-2, 203F, 203G-1, 203G-2 and zero or more outputs, 205A, 205B, 205C-1, 205C-2, 205D, 205E, and 205F. The outputs of a node may be used as the inputs to other nodes.

Each node performs a particular operation on its inputs and generates a result which is rendered in a render view area 204A-204G. The operation associated with each node may be represented by a code fragment written in a shader language. A shader language is a programming language tailored for programming graphics hardware. There are well-known several shader languages, such as High Level Shader Language (HLSL), Cg, OpenGL (GLSL), and SH, and any of these shader languages may be utilized.

For example, node 202A, contains the texture coordinate of a pixel whose color is being generated, 205C. The texture coordinate represents the index of the pixel, in terms of its x, y coordinates, in a 2D bitmap. Node 202C receives the pixel index, 203C, from node 202A and performs a texture sample operation which reads the color value of the pixel at the location specified by the pixel index in a 2D bitmap. The code fragment associated with node 202C may be written in HLSL as follows:

Texture1.Sample (TexSampler, pixel.uv),

where Texture1.Sample is a function that reads the color value of the pixel from the data structure TexSampler, at the position indicated by pixel.uv.

Upon activation of this texture sample operation, the color value is rendered in the render view area 204C of node 202C and output 205C-1, 205C-2 for use in subsequent operations.

Node 202B represents a Lambert model, which is used to specify the direction of a light source, that is applied to the pixel. The HLSL code fragment associated with node 202B may be as follows:

LambertLighting (tangentLightDir,
float3(0.000000f 0.000000f, 1.000000f),
AmbientLight.rgb,
MaterialAmbient.rgb,
LightColor[0]. rgb,
pixel. diffuse. rgb);
   where LambertLighting is a function that defines the diffuse lighting model. The parameters, tangentLightDir, AmbientLight. rgb, MaterialAmbient. rgb, LightColor[0]. rgb, and pixel. diffuse. rgb are used to specify the direction, material, and amount of light used in the model. The value of the Lambert model is output, 205B, for use in a subsequent operation.

Node 202E is a multiply node, that computes a product, x*y, of its two inputs, 203E-1, 203E-2, which will produce the color of a pixel using the intensity of the reflectance of the light specified by the Lambert model. This color is rendered in the render view area 204E of node 202E.

Node 202D represents the current color of the pixel based on the partial transformations made by the vertex shader on the pixel. The current color is rendered in the render view area 204D of node 202D. The point color, 205D, is input to node 202F along with the color value of the pixel color, 205C-1, from node 202C. Node 202F computes the sum, x+y, of its two inputs which generates the resulting color from the combination of the two colors, which is shown in the render view area 204F of node 202F and output, 205F, to node 202G.

Node 202G receives the outputs, 205E, 205F, from nodes 202E, 202F and generates the final color as the combination of the colors of its inputs. The final color is rendered in the render view area 204G of node 202G. As shown in FIG. 2, the render view area in each node provides a developer with a real-time view of the result of each operation in combination with other operations. In this manner, errors may be detected more readily and remedied quickly.

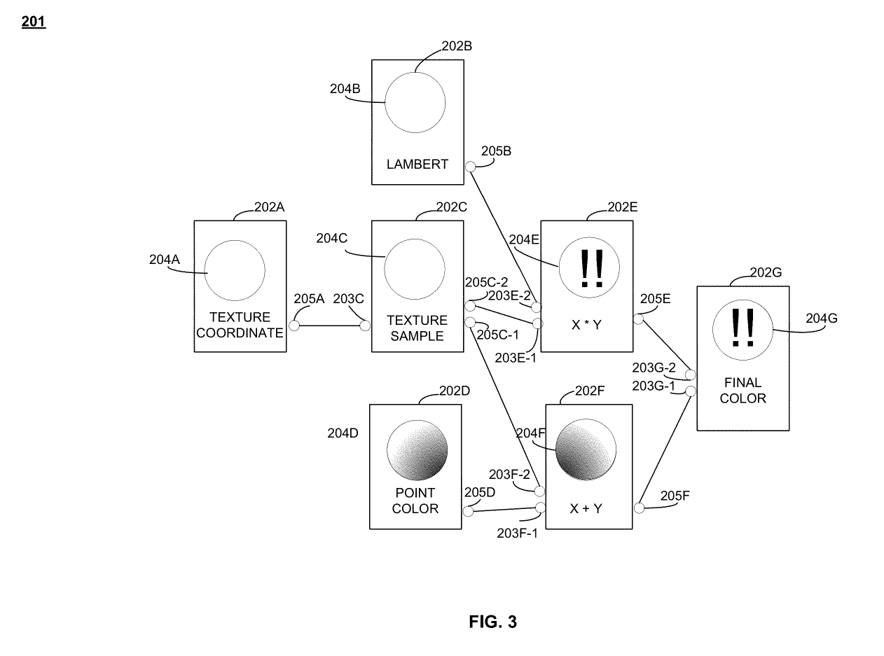

FIG. 3 illustrates a pixel shader embodied as a DAG visually displaying an error texture that indicates an erroneous condition or construction of the sequence of nodes. In particular, an error shader may render the error texture in the render view area of nodes 202E, 202G to alert the developer to an error. For example, the Lambert model may have produced invalid values resulting in an erroneous condition. Since the output of node 202E is input to node 202G, the render view areas in both of these nodes, 204E, 204G, displays an error texture. A developer may recognize the affected nodes more readily due to the error texture thereby leading the developer to the source of the error during development. Attention now turns to a description of a system for developing a pixel shader in real time.

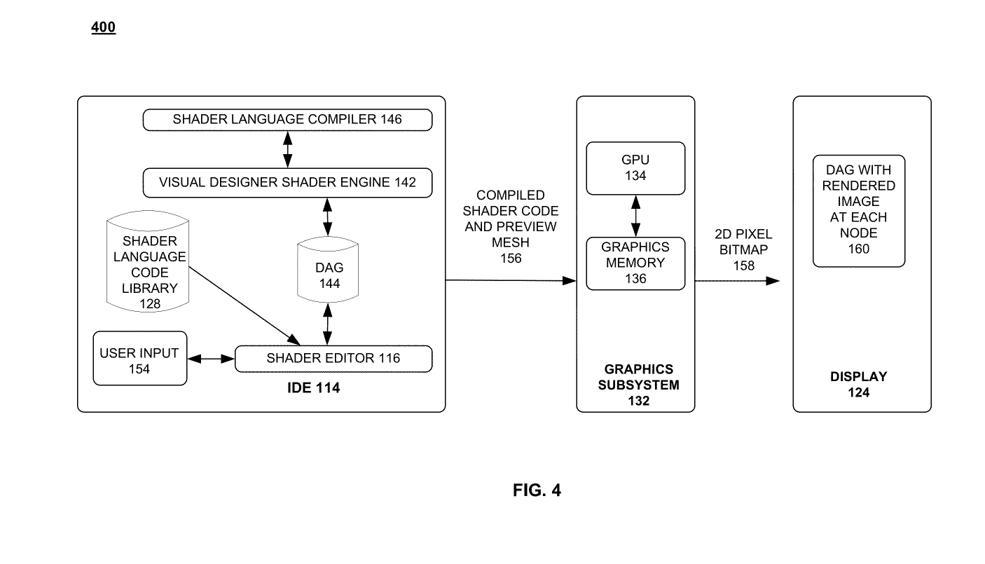

FIG. 4 illustrates an exemplary system 400 for designing a pixel shader. Although the system 400 shown in FIG. 4 has a limited number of components in a certain configuration, it may be appreciated that the system 400 may include more or less components in alternate configurations for a given implementation.

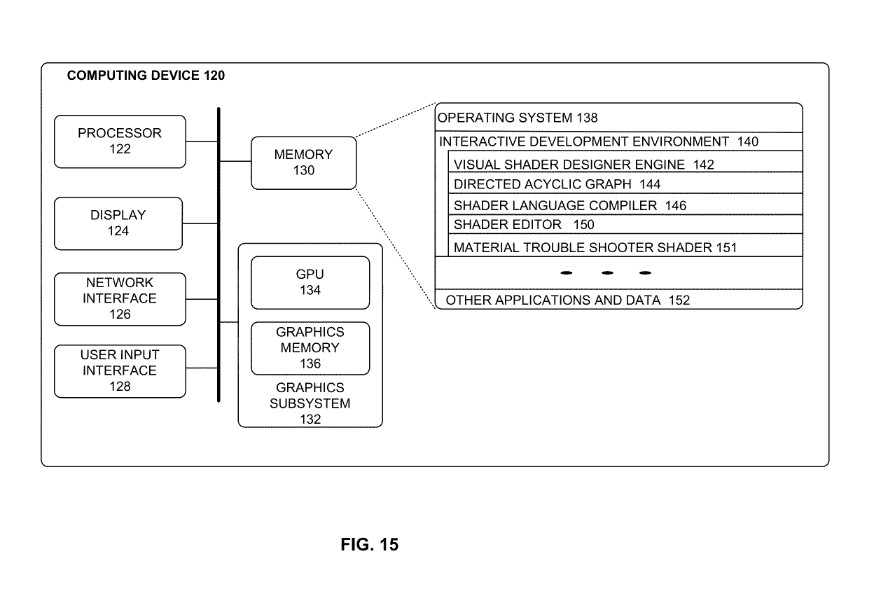

The system 400 may include an interactive development environment (IDE) 114 coupled to a graphics subsystem 132, which may be coupled to a display 124. The IDE 114, graphics subsystem 132, and display 124 may be components of a single electronic device or may be distributed amongst multiple electronic devices. The graphics subsystem 132 may contain a GPU 134 and a graphics memory 136. The graphics subsystem 132 and display 124 are well known components of a computer-implemented system and may be described in more detail below with respect to FIG. 15.

The IDE 114 may include a shader editor 116, a shader language code library 128, a visual designer shader engine 142, and a shader language compiler 146. The shader editor 116 may be used by a developer to generate a shader through user input 154. The shader language code library 128 contains code fragments containing programmable instructions that are contained in a node in the DAG 144. The visual designer shader engine 142 generates a rendered image for each node in the DAG 144. A shader language compiler 146 may be used to compile the code fragments in each node of the DAG 144 into an executable format for execution on a GPU 134. The output of the IDE may be the compiled shader code and a preview mesh which may be transmitted to the graphics subsystem 132. The graphics subsystem 132 executes the compiled shader code and transforms the preview mesh into a 2D pixel bitmap 158. The 2D pixel bitmap 158 is rendered onto the render view area of a node 160 of the DAG 144 in a display 124.

Attention now turns to a description of embodiments of exemplary methods used to construct a pixel shader using a visual shader designer engine. It may be appreciated that the representative methods do not necessarily have to be executed in the order presented, or in any particular order, unless otherwise indicated. Moreover, various activities described with respect to the methods can be executed in serial or parallel fashion, or any combination of serial and parallel operations. The methods can be implemented using one or more hardware elements and/or software elements of the described embodiments or alternative embodiments as desired for a given set of design and performance constraints. For example, the methods may be implemented as logic (e.g., computer program instructions) for execution by a logic device (e.g., a general-purpose or specific-purpose computer).

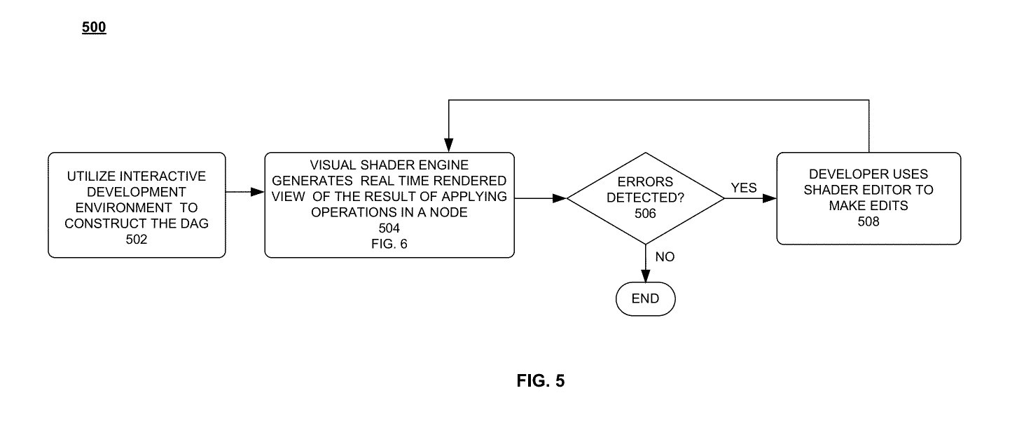

FIG. 5 illustrates a flow diagram of an exemplary method for designing a pixel shader. It should be noted that the method 500 may be representative of some or all of the operations executed by one or more embodiments described herein and that the method can include more or less operations than that which is described in FIG. 5.

An interactive development environment 114 may be a software application having a collection of tools, such as a shader editor 116 and a virtual shader designer engine 142. The shader editor 116 may include a graphical user interface having visual components, such as menus, buttons, icons, etc., that enable a developer to develop a directed acyclic graph representing a pixel shader, such as the directed acyclic graph shown in FIG. 1 (block 502). Upon completion of the directed acyclic graph, the developer may utilize the visual shader designer engine 142 to produce a visualization of the operation in each node in the directed acyclic graph (block 504). If an error is detected (block 506—yes), then the developer may use the shader editor 116 to make edits to the directed acyclic graph (block 508). The developer may then re-engage the visual shader designer engine 142 again to obtain a visualization of the results (block 504). Otherwise, if no errors are detected (block 506—no), then the process ends.

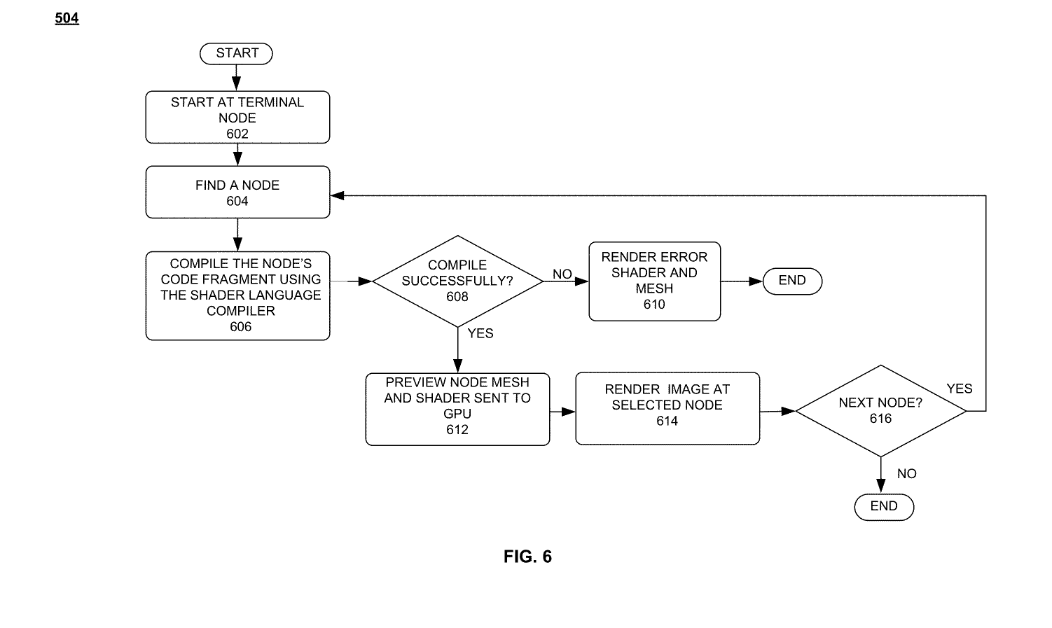

FIG. 6 illustrates an exemplary method of the visual shader designer engine 142 in generating a rendered view in each node of the directed acyclic graph. The visual shader designer engine 142 obtains a directed acyclic graph and traverses each node in the graph in a prescribed manner starting at the terminal node (block 602). The visual shader designer engine 142 locates the terminal node, which acts as a root node for the traversal. From the terminal node, the directed acyclic graph is recursively traversed in post order to select a node to process. The leaf nodes are selected first and then the nodes that receive their input, and so forth until the terminal node is reached.

The visual shader designer engine 142 traverses the DAG to find a node to process (block 604). The code fragments aggregated at the node are compiled using the shader language compiler 146 (block 606). If the node's code fragments do not compile successfully (block 608—no), then an error texture may be rendered in the nodes' render view area (block 610) and the process ends. An error texture is a unique texture that indicates an error. In one or more embodiments, a material trouble shooter shader 151 may be used to render the error texture.

Otherwise, if the code fragments compiled successfully (block 608—yes), the node's preview mesh and compiled code fragments are sent to the GPU (block 612) where the resulting image is rendered in the node's render view area (block 614). If there is another node to process, (block 616—yes), then the process repeats for the next node. Otherwise, when the current node being processed is the terminal node, then the process is completed and ends (block 616—no).

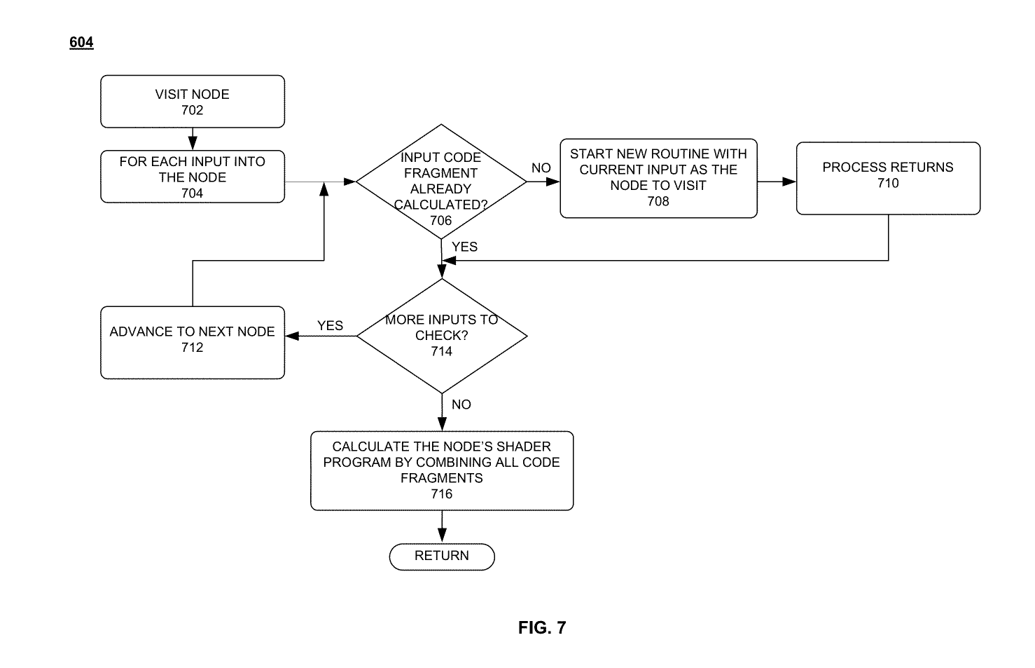

FIG. 7 illustrates an exemplary method for traversing the DAG in a prescribed manner to calculate the code fragments of each node. The calculation of the code fragment in a node requires aggregating the code fragments associated with the node and the code fragments associated with all the inputs to the node. As such, the calculation starts with the leaf nodes in the DAG and works through the internal nodes in the DAG until the terminal node is reached. At the terminal node, the calculation will have aggregated all the code fragments in the DAG into a shader program.

The process visits a given node (block 702). The input nodes to the given node are then processed one at a time (block 704). The process checks if the code fragment of the input node has been calculated (block 706). The calculation of a node is the aggregation of the node's code fragment with each of the code fragments of each of its inputs. If the code fragment of the node's input has not been calculated (block 706—no), then the process calls itself recursively with the current input node as the node to visit (block 708). When the process returns (block 710), it then checks if there are more input nodes to check (block 714) and proceeds accordingly.

If the input node's code fragment has already been calculated (block 706—yes), then the process proceeds to check if the node has additional input nodes (block 714). If there are more input nodes (block 714—yes), then the process advances to the next node (block 712). If there are no further input nodes to check (block 714), then the current node needs to be calculated. This is done by aggregating the node's code fragment with the code fragments of each input node (block 716). The process returns to FIG. 6, block 604, and then proceeds to compile the node's code fragment as noted above.

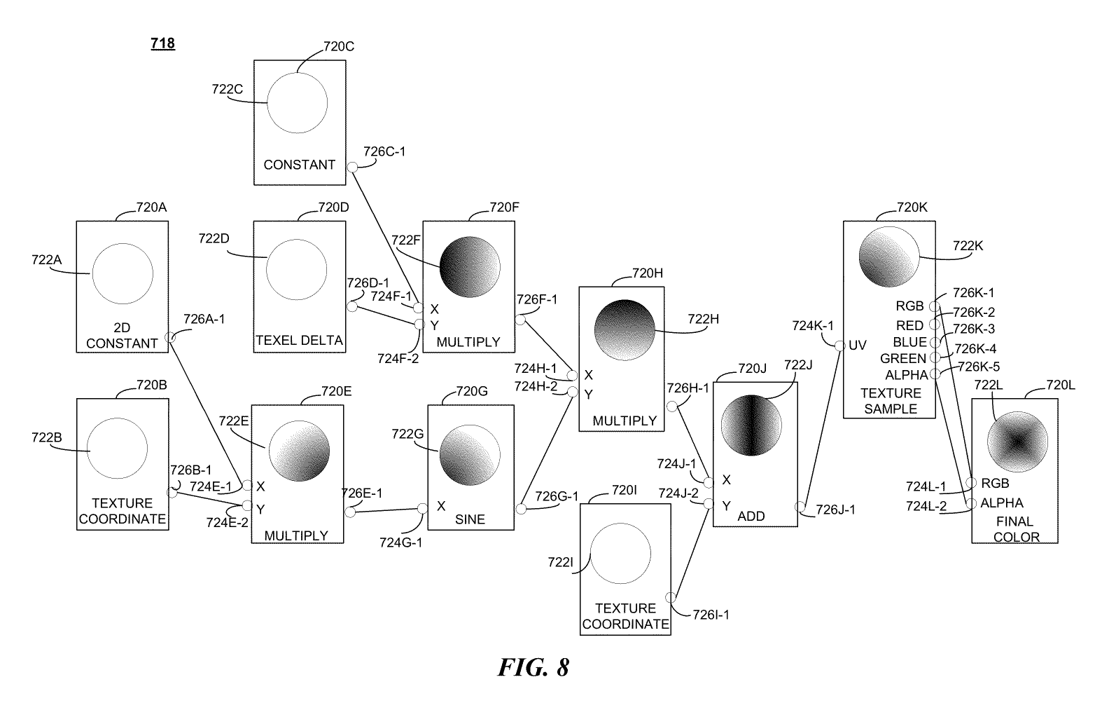

Attention now turns to a discussion of the creation of an image filter. FIG. 8 illustrates an image filter embodied as a DAG 718. The DAG 718 represents a ripple image filter that, when applied to a group of pixels in an image, generates a ripple across an image by applying a sine wave curve to each pixel thereby shifting the pixels around in the image to create a ripple effect. The DAG 718 shows the operations and/or values that are applied to a single pixel in order to generate a new color for the pixel that produces the ripple effect.

The DAG 718 has twelve nodes 720A-720L connected to form directed routes that end at a terminal node 720L. For example, there is a directed route that commences at source node 720C and traverses in order, to node 720F to node 720H, to node 720J, to node 720K, and ends at terminal node 720L. A second directed route commences at source node 720D and traverses in order to node 720F, to node 720H, to node 720J, to node 720K, and ends at terminal node 720L. A third directed route commences at source node 720A and traverses in order, to node 720E, to node 720G, to node 720H, to node 720J, to node 720K, and ends at terminal node 720L.

Each node, 720A-720L, may have zero or more inputs, 724E-1, 724E-2, 724F-1, 724F-2, 724G-1, 724H-1, 724H-2, 724J-1, 724J-2, 724K-1, 724L-1, 724L-2 and zero or more outputs, 726A-1, 726B-1, 726C-1, 726D-1, 726E-1, 726F-1, 726G-1, 726H-1, 726I-1, 726J-1, 726K-1, 726K-2, 726K-3, 726K-4, 726K-5. The outputs of a node may be used as the inputs to other nodes.

Each node performs a particular operation on its inputs and generates a result which is rendered in a render view area 722A-722L. The operation associated with each node may be represented by a code fragment written in a shader language. A shader language is a programming language tailored for programming graphics hardware. There are well-known several shader languages, such as High Level Shader Language (HLSL), Cg, OpenGL (GLSL), and SH, and any of these shader languages may be utilized.

As shown in FIG. 8, node 722A, contains a value of the two-dimensional constant that is used to convert a pixel's incoming texture coordinate to an angle, specified in radians. The render view area 722A shows the constant as a color. A two-dimensional constant may be represented as a (X,Y) pair. For example, (1,0) may represent a red color and (0,1) may represent a green color. Assuming this color configuration, the render view area 722A may show a color that is a combination of red and green.

The code fragment associated with node 722A may be written in HLSL as follows:

float2 local1=float2 (X,Y);

where local1 is a variable set to the value of the (X,Y) pair designated by a developer.

Node 722B, contains the texture coordinate of a pixel whose color is being generated. The texture coordinate represents the index of the pixel, in terms of its x, y coordinates, in a 2D bitmap. Node 722B receives the pixel index from output of the previous steps in the graphics pipeline and performs a texture sample operation which reads the color value of the pixel at the location specified by the pixel index in a 2D bitmap. The code fragment associated with node 722B may be written in HLSL as follows:

Texture1. Sample (TexSampler, pixel.uv),

where Texture1. Sample is a function that reads the color value of the pixel from the data structure TexSampler, at the position indicated by pixel. uv.

Upon activation of this texture sample operation, the color value is rendered in the render view area 722B and output 726B-1 is used in a subsequent operation.

Node 720E is a multiply node, that computes a product, x*y, of its two inputs, 724E-1, 724E-2, which will convert the texture coordinate into an angular value, in radians, that is then used as an input to the sine node, 720G.

Node 720C represents a constant value that is used to define the size of the ripple in pixels for the visual effect. The render view area 722C may display the value as a grayscale color. The code fragment associated with node 720C may be written in HLSL as follows:

float local2=15;

where local2 is a variable that contains the constant value 15.

Node 722D represents a texel delta that describes a distance vector between texels in the texture image. The code fragment associated with node 720C may be written in HLSL as follows:

float2 local3=GetTexelDelta(Texture1);

where GetTexelDelta( ) is a predefined function.

Node 720F is a multiplication operation that scales the texel delta by a specified number of pixels. Node 720F receives an input 724F-1 from node 720C and input 724F-2 from node 720D. When the outcome of the operations in a node is a mathematically result, such as a vector, the render viewing area may display a single color or a color that denotes when the mathematical result is within a particular range, such as >1. The render viewing area 722F may display any such color. The code fragment associated with node 720F may be written in HLSL as follows:

float2 local4=local3*local2

Node 720G takes as input the converted texture coordinate specified in radians and outputs the sine value for the specific radian angle of a pixel in the texture image The render viewing area 722G may display any color indicative of the results of this mathematical operation. The code fragment associated with node 720F may be written in HLSL as follows:

float2 local6=sin(local5)

Node 720H is a multiplication operation configured to generate a texture coordinate offset vector. Node 720H receives input 724H-1 and 724H-2 and generates any color in the render view area 722H. The code fragment associated with node 720H may be written in HLSL as follows:

float2 local7=local6*local4;

Node 720I contains the texture coordinate of a pixel and receives the pixel index from output of the previous steps in the graphics pipeline. Node 720I performs a texture sample operation which reads the color value of the pixel at the location specified by the pixel index in a 2D bitmap and is similar to the operation described above with respect to node 720B.

Node 720J is an addition operation configured to offset the current texture coordinate by the coordinate offset vector previously computed. Node 720J receives input 724J-1 and 724J-2 and generates any color in the render view area 722J. The code fragment associated with node 720J may be written in HLSL as follows:

float2 local8=local7+pixel.uv;

Node 720K contains the texture coordinate of another pixel. The texture coordinate represents the index of the pixel, in terms of its x, y coordinates, in a 2D bitmap. Node 720K receives the pixel index from the output of node 720J and performs a texture sample operation which reads the color value of the pixel at the location specified by the pixel index in a 2D bitmap. The code fragment associated with node 722B may be written in HLSL as follows:

Texture1.Sample (TexSampler,local8),

where Texture1.Sample is a function that reads the color value of the pixel from the data structure TexSampler, at the position indicated by local8.

The outputs of node 720K may include one or more colors such as, RGB 726K-1, Red 726K-2, Blue 726K-3, Green 726K-4, and Alpha 726K-5. Node 720K, in this illustration, outputs RGB 726K-1 and alpha 726K-5 to node 720L.

Node 720L, is a terminal node, that represents the final color of a pixel which includes the ripple effect. Node 720L receives a RGB input value 724L-1 and an alpha input vale 724L-2 from the texture sample node 720K and generates the final color which is rendered in render view area 722L.

Attention now turns to a discussion of a system for creating an image filter. Referring to FIG. 4, the system 400 may utilize an IDE 114 having a shader editor 116, a shader language code library 128, a visual designer shader engine 142, and a shader language compiler 146. The shader editor 116 may include a graphical user interface that enables a user to construct a DAG representing the image filter. The graphical user interface may include buttons, menus, icons, and other graphic elements that may be used by a developer to construct the image filter's graphical representation or DAG. Each node of a DAG is associated with a particular value or mathematical operation. The code fragments corresponding to a node may be stored in a shader language code library 128.

The visual designer shader engine 142 generates a rendered image for each node in the DAG 144. In order to generate the rendered image, the code fragments corresponding to each node are aggregated and compiled by a shader language compiler 146 into an executable format for execution on a GPU 134. The visual designer shader engine 142 executes on a processing unit that is different from the GPU 134.

The output of the IDE may be the compiled image filter code and a preview mesh which may be transmitted to the graphics subsystem 132. The graphics subsystem 132 executes the compiled code and transforms the preview mesh into a 2D pixel bitmap 158. The 2D pixel bitmap 158 is rendered onto the render view area of a node 160 of the DAG 144 in a display 124.

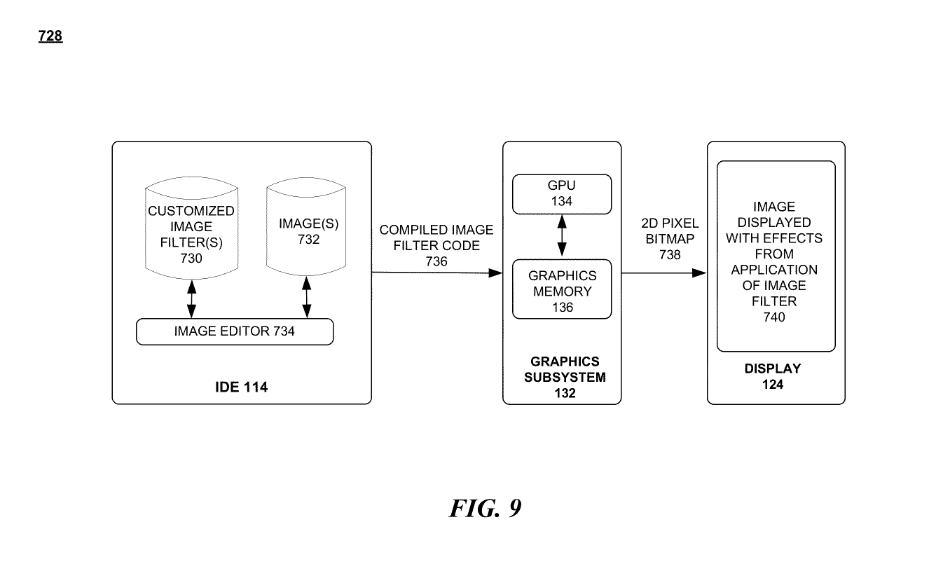

Referring to FIG. 9, the IDE 114 may also include an image editor 734, a repository of customized image filters 730, and a repository of digital images 732. Upon completion of the creation of the DAG representing the customized image filter, the DAG may be compiled by the shader language compiler 146 into executable instructions that may be stored in the repository of customized image filters 730. The developer may utilize an image editor 734 to apply the customized image filter 730 to an image 732 or a portion of an image 732. The image editor 734 initiates the graphics subsystem 132 to execute the image filter's compiled code 736 onto an image thereby generating a new 2D pixel bitmap 738 that is drawn onto a display 124. The 2D pixel bitmap 738 is used to display the image having the visual effects resulting from application of the image filter 740.

It should be noted that the IDE 114 and the components therein (i.e., visual shader designer engine 142, shader language compiler 146, shader editor 150, image editor 734) may be a sequence of computer program instructions, that when executed by a processor, causes the processor to perform methods and/or operations in accordance with a prescribed task. The IDE 114 and associated components may be implemented as program code, programs, procedures, module, code segments, program stacks, middleware, firmware, methods, routines, and so on. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

Attention now turns to a description of embodiments of exemplary methods used to construct an image filter. It may be appreciated that the representative methods do not necessarily have to be executed in the order presented, or in any particular order, unless otherwise indicated. Moreover, various activities described with respect to the methods can be executed in serial or parallel fashion, or any combination of serial and parallel operations. The methods can be implemented using one or more hardware elements and/or software elements of the described embodiments or alternative embodiments as desired for a given set of design and performance constraints. For example, the methods may be implemented as logic (e.g., computer program instructions) for execution by a logic device (e.g., a general-purpose or specific-purpose computer).

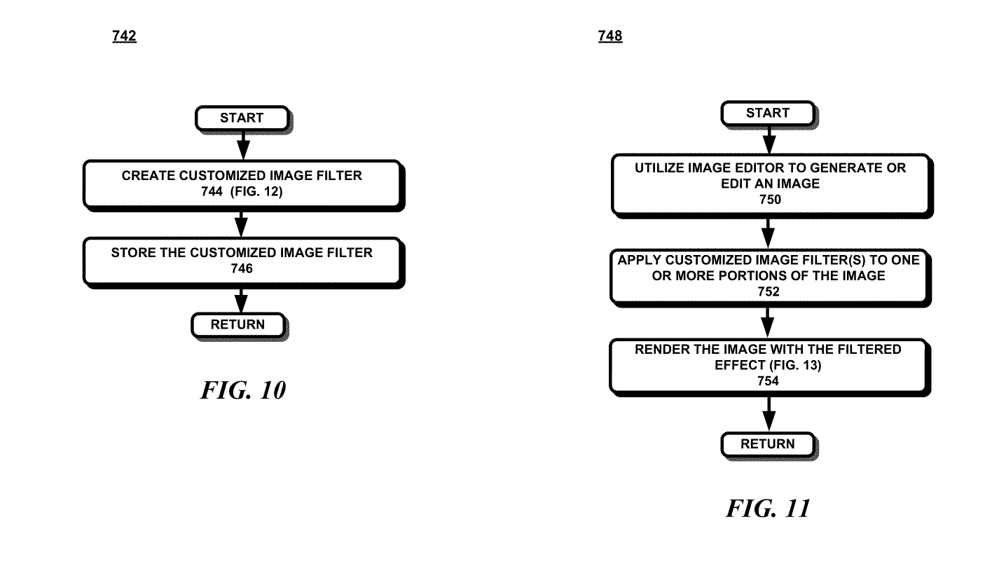

FIGS. 10-13 are flow diagrams of exemplary methods for creating and applying a customized image filter. It should be noted that the methods may be representative of some or all of the operations executed by one or more embodiments described herein and that the method can include more or less operations than that which is described in FIGS. 10-13.

FIG. 10 is an exemplary method 742 for creating a customized image filter. Referring to FIG. 10, a developer may utilize an interactive development environment to create a customized image filter (block 744) which may be stored (block 746) for application, over time, to numerous images.

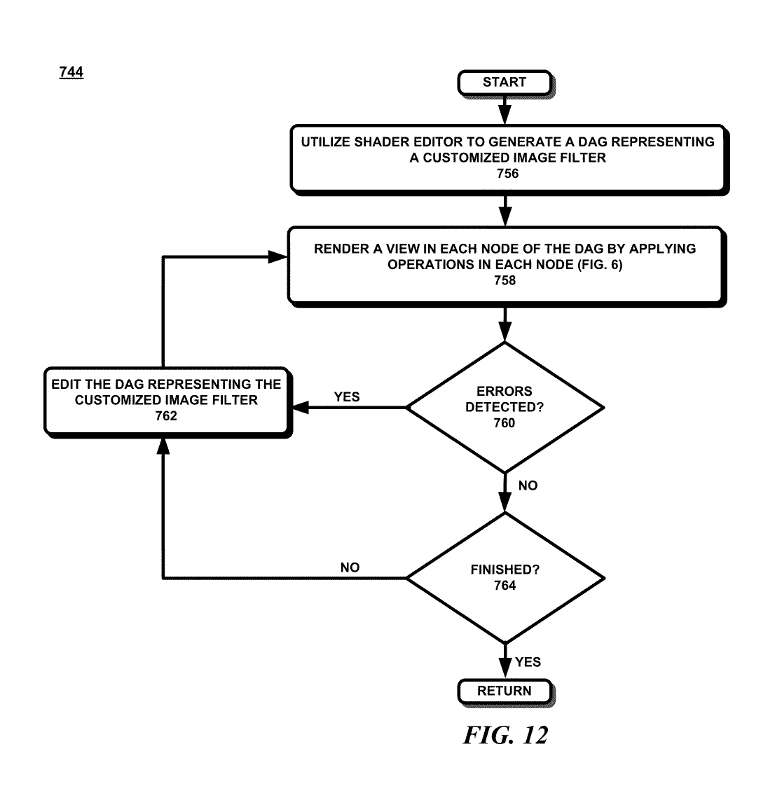

FIG. 11 is an exemplary method 748 for applying the customized image filter to an image. Referring to FIG. 11, the developer may utilize an image editor to generate or edit an image (block 750). The developer may apply one or more customized image filters to one or more portions of the image (block 752). The image editor initiates the process of rendering the image with the filtered effect produced by using the image filter (block 754).

FIG. 12 illustrates the process 144 of creating an image filter. A developer may utilize a shader editor to generate a DAG representing the customized image filter (block 756). The visual shader designer engine may then be utilized to render a view in each node by applying operations and values defined in each node (block 758). The real-time rendering of the image filter is performed as noted above with respect to FIGS. 6 and 7.

The view rendered in each node may result in errors. If errors are detected (block 760—yes), then the developer may edit the DAG (block 762) and execute the operations specified in the DAG until no further errors are detected (block 760—no). The process may be repeated (block 764—no) until the developer finishes (block 764—yes).

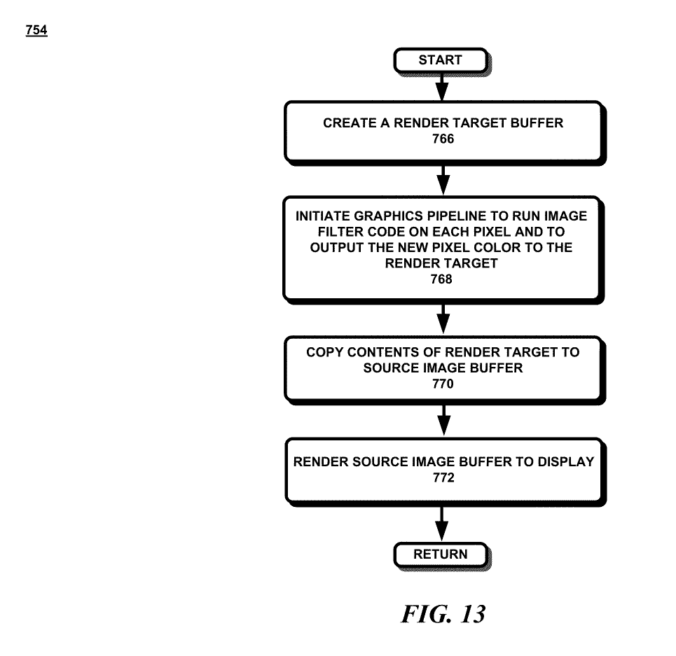

FIG. 13 illustrates the process of applying an image filter to an image. A developer, through an image editor, selects an image filter and an area of an image where the image filter is to be applied. The image editor then creates a render target or buffer in the graphics memory that is the same size as the source image buffer that stores the contents of the currently displayed image (block 766). The image editor initiates the graphics pipeline to run the image filter on each pixel in the source image buffer and to output the new color of the pixel in the render target (block 768). The contents of the render target are then copied to the source image buffer (block 770) and the contents of the source image buffer are rendered onto a display (block 772).

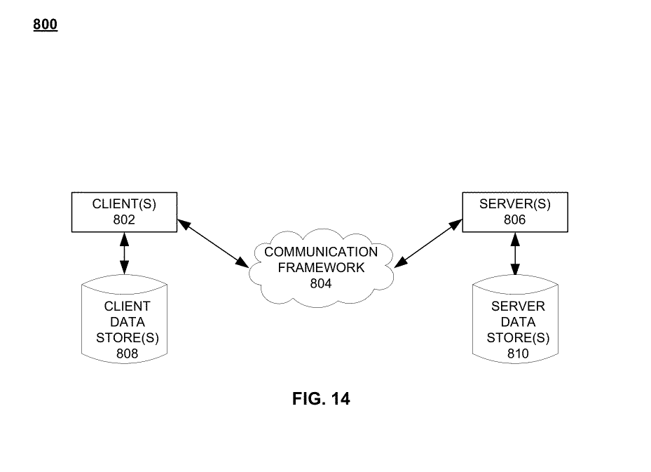

Attention now turns to a discussion of an exemplary operating environment for the visual shader designer. Referring now to FIG. 14, there is shown a schematic block diagram of an exemplary operating environment 800. It should be noted that the operating environment 800 is exemplary and is not intended to suggest any limitation as to the functionality of the embodiments. The embodiments may be applied to an operating environment having one or more client(s) 802 in communication through a communications framework 804 with one or more server(s) 806. The operating environment may be configured in a network environment or distributed environment having remote or local storage devices. Additionally, the operating environment may be configured as a stand-alone computing device having access to remote or local storage devices.

The client(s) 802 and the server(s) 806 may be any type of electronic device capable of executing programmable instructions such as, without limitation, a mobile device, a personal digital assistant, a mobile computing device, a smart phone, a cellular telephone, a handheld computer, a server, a server array or server farm, a web server, a network server, an Internet server, a work station, a mini-computer, a mainframe computer, a supercomputer, a network appliance, a web appliance, a distributed computing system, multiprocessor systems, or combination thereof.

The communications framework 804 may be any type of communications link capable of facilitating communications between the client(s) 802 and the server(s) 806, utilizing any type of communications protocol and in any configuration, such as without limitation, a wired network, wireless network, or combination thereof. The communications framework 404 may be a local area network (LAN), wide area network (WAN), intranet or the Internet operating in accordance with an appropriate communications protocol.

In one or more embodiments, the operating environment may be implemented as a computer-implemented system having multiple components, programs, procedures, modules. As used herein these terms are intended to refer to a computer-related entity, comprising either hardware, a combination of hardware and software, or software. For example, a component may be implemented as a process running on a processor, a hard disk drive, multiple storage drives (of optical and/or magnetic storage medium), an object, an executable, a thread of execution, a program, and/or a computing device. By way of illustration, both an application running on a server and the server may be a component. One or more components may reside within a process and/or thread of execution, and a component may be localized on one computer and/or distributed between two or more computers as desired for a given implementation. The embodiments are not limited in this manner.

FIG. 15 illustrates a block diagram of an exemplary computing device 120 implementing the visual shader designer. The computing device 120 may have a processor 122, a display 124, a network interface 126, a user input interface 128, a graphics subsystem 132, and a memory 130. The processor 122 may be any commercially available processor and may include dual microprocessors and multi-processor architectures. The display 124 may be any visual display unit. The network interface 126 facilitates wired or wireless communications between the computing device 120 and a communications framework. The user input interface 128 facilitates communications between the computing device 120 and input devices, such as a keyboard, mouse, etc. The graphics subsystem 132 is a specialized computing unit for generating graphic data for display. The graphics subsystem 132 may be implemented as a graphics card, specialized graphic circuitry, and the like. The graphics subsystem 132 may include a graphic processing unit (GPU) 134 and a graphics memory 136.

The memory 130 may be any computer-readable storage media that may store executable procedures, applications, and data. It may be any type of memory device (e.g., random access memory, read-only memory, etc.), magnetic storage, volatile storage, non-volatile storage, optical storage, DVD, CD, floppy disk drive, and the like. The computer-readable media does not pertain to propagated signals, such as modulated data signals transmitted through a carrier wave. The memory 130 may also include one or more external storage devices or remotely located storage devices. The memory may 130 contain instructions and data as follows:
an operating system 138;
a interactive development environment 140 including a visual shader designer engine 142, a directed acyclic graph 144, a shader language compiler 146, a shader editor 150, and a material trouble shooter shader 151; and
various other applications and data 152.

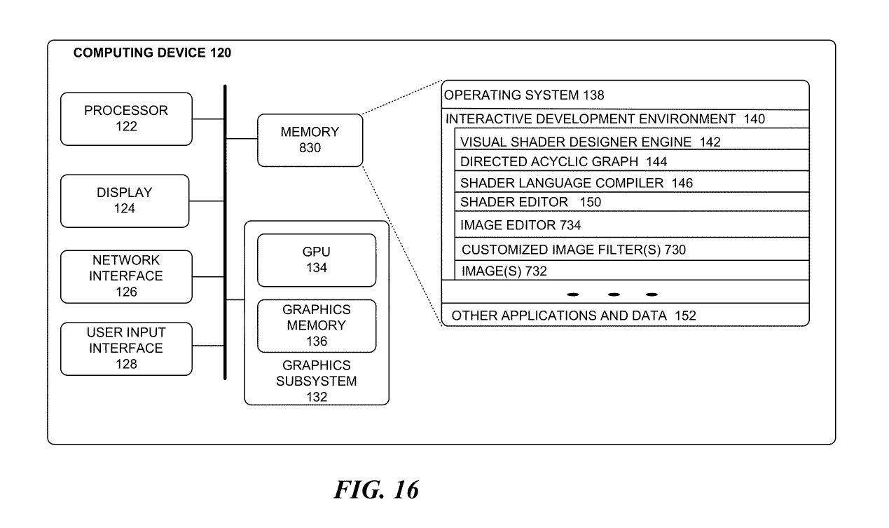

FIG. 16 illustrates a block diagram of a second embodiment of an exemplary computing device 120. The computing device 120 may have a processor 122, a display 124, a network interface 126, a user input interface 128, a graphics subsystem 132, and a memory 830. The processor 122 may be any commercially available processor and may include dual microprocessors and multi-processor architectures. The display 124 may be any visual display unit. The network interface 126 facilitates wired or wireless communications between the computing device 120 and a communications framework. The user input interface 128 facilitates communications between the computing device 120 and input devices, such as a keyboard, mouse, etc. The graphics subsystem 132 is a specialized computing unit for generating graphic data for display. The graphics subsystem 132 may be implemented as a graphics card, specialized graphic circuitry, and the like. The graphics subsystem 132 may include a graphic processing unit (GPU) 134 and a graphics memory 136.

The memory 830 may be any computer-readable storage media that may store executable procedures, applications, and data. It may be any type of memory device (e.g., random access memory, read-only memory, etc.), magnetic storage, volatile storage, non-volatile storage, optical storage, DVD, CD, floppy disk drive, and the like. The computer-readable media does not pertain to propagated signals, such as modulated data signals transmitted through a carrier wave. The memory 830 may also include one or more external storage devices or remotely located storage devices. The memory may 830 contain instructions and data as follows:
an operating system 138;
a interactive development environment 140 including a visual shader designer engine 142, a directed acyclic graph 144, a shader language compiler 146, a shader editor 150, an image editor 734, one or more customized image filter(s) 730, one or more image(s) 732; and
various other applications and data 152.

In various embodiments, the systems described herein may comprise a computer-implemented system having multiple elements, programs, procedures, modules. As used herein, these terms are intended to refer to a computer-related entity, comprising either hardware, a combination of hardware and software, or software. For example, an element may be implemented as a process running on a processor, a hard disk drive, multiple storage drives (of optical and/or magnetic storage medium), an object, an executable, a thread of execution, a program, and/or a computer. By way of illustration, both an application running on a server and the server may be an element. One or more elements may reside within a process and/or thread of execution, and an element may be localized on one computer and/or distributed between two or more computers as desired for a given implementation. The embodiments are not limited in this manner.

It should be noted that although the visual shader designer engine has been described as a component to an interactive development environment, the embodiments are not limited to this configuration of the visual shader designer engine. The visual shader designer engine may be a stand-alone application, combined with another software application, or used in any other configuration as desired.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Various embodiments may be implemented using hardware elements, software elements, or a combination of both. Examples of hardware elements may include devices, components, processors, microprocessors, circuits, circuit elements, integrated circuits, application specific integrated circuits, programmable logic devices, digital signal processors, field programmable gate arrays, memory units, logic gates and so forth. Examples of software elements may include software components, programs, applications, computer programs, application programs, system programs, machine programs, operating system software, middleware, firmware, software modules, routines, subroutines, functions, methods, procedures, software interfaces, application program interfaces, instruction sets, computing code, code segments, and any combination thereof. Determining whether an embodiment is implemented using hardware elements and/or software elements may vary in accordance with any number of factors, such as desired computational rate, power levels, bandwidth, computing time, load balance, memory resources, data bus speeds and other design or performance constraints, as desired for a given implementation.

Some embodiments may comprise a storage medium to store instructions or logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software components, such as programs, procedures, module, applications, code segments, program stacks, middleware, firmware, methods, routines, and so on. In an embodiment, for example, a computer-readable storage medium may store executable computer program instructions that, when executed by a processor, cause the processor to perform methods and/or operations in accordance with the described embodiments. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

What is claimed:

1. A computer-implemented method, comprising:
creating a customized image filter utilizing an editor that enables a developer to construct the customized image filter as a directed acyclic graph, the directed acyclic graph having a plurality of nodes configured to form one or more routes that terminate at a terminal node, the terminal node representing a color of a pixel incorporating a visual effect produced by application of operations associated with each node; and
rendering, during creation of the customized image filter, a visual display, in each node, representing application of an operation associated with a node.

2. The computer-implemented method of claim 1, the rendering step further comprising:
performing the operations associated with each node on a graphics processing unit to generate the visual display.

3. The computer-implemented method of claim 2, further comprising:
associating each operation corresponding to a node with a code fragment; and
compiling each code fragment into executable instructions.

4. The computer-implemented method of claim 3, further comprising:
executing the executable instructions on a graphics processing unit to render the visual display.

5. The computer-implemented method of claim 3, the compiling step further comprising:
translating each code fragment into executable instructions written in a shader programming language into executable instructions that execute on a graphics processing unit.

6. The computer-implemented method of claim 1, further comprising:
editing an image by applying the customized image filter to the image.

7. The computer-implemented method of claim 6, further comprising:
utilizing a graphics pipeline to execute executable instructions representing the customized image filter onto a set of pixels within the image.

8. The computer-implemented method of claim 1, further comprising:
applying the customized image filter to alter a color of one or more pixels within an image to produce a specific visual effect.

9. The computer-implemented method of claim 1, wherein the editor is a shader editor.

10. A computer-readable storage medium storing thereon processor-executable instructions, comprising:
an interactive development environment having processor-executable instructions that allow a developer to generate a directed acyclic graph, the directed acyclic graph having a plurality of nodes, each node containing a first set of executable instructions associated with performing an operation on a pixel or associating a value, the directed acyclic graph configured to produce a customized visual effect on a single pixel, the customized visual effect used to transform an existing color of a pixel to a new color in accordance with a configuration of the operations,
the interactive development environment having processor-executable instructions that transforms each first set of executable instructions into a second set of executable instructions and initiates a graphics processing unit to execute each second set of executable instructions to render a view of the results from execution of each second set of executable instructions in each node.

11. The computer-readable storage medium of claim 10, the interactive development environment including processor-executable instructions that generate a final set of executable instructions by accumulating all second sets of executable instructions in an order formed by recursively traversing each node from a terminal node.

12. The computer-readable storage medium of claim 11, the interactive development environment including processor-executable instructions that stores the final set of executable instructions as a customized image filter.

13. The computer-readable storage medium of claim 12, the interactive development environment including processor-executable instructions that allow a developer to apply the customized image filter to an image.

14. The computer-readable storage medium of claim 10, wherein the first set of executable instructions include instructions written in a shader programming language.

15. The computer-readable storage medium of claim 11, wherein the second set of executable instructions is associated with a format recognizable by the graphics processing unit.

16. A computer-implemented system, comprising:
a first processor and a first memory, the first memory having a shader editor and a visual shader designer engine,
the shader editor having instructions that when executed on the first processor, enables a developer to generate a directed acyclic graph representing a customized image filter, the customized image filter having instructions configured to alter a first color of a plurality of pixels of an image to a second color representing a customized visual effect,
the visual shader designer engine having instructions that when executed on the first processor generates a final set of instructions for each node in the directed acyclic graph; and
a graphics processor that executes the final set of instructions for each node and renders a graphic image resulting from execution of the final set of instructions in each node.

17. The computer-implemented system of claim 16, wherein each node in the directed acyclic graph has a rendered view area for displaying a view resulting from execution of the final set of instructions associated with a node.

18. The computer-implemented system of claim 16, wherein the first processor and the graphics processor are different.

19. The computer-implemented system of claim 16, the first memory having an image editor, the image editor having processor-executable instructions that when executed on the first processor, applies the customized image filter to an image.

20. The computer-implemented system of claim 16, the shader editor having processor-executable instructions that enables a developer to create nodes in the directed acyclic graph, to connect outputs of one or more nodes to inputs of other nodes, to associate operations and values to a node, and to associate instructions for each operation of a node.
